(19) United States
(12) Patent Application Publication
(10) Pub. No.: US 2023/0292020 A1
(43) Pub. Date: Sep. 14, 2023

(54) LENS DISTORTION CORRECTION FOR IMAGE PROCESSING

(71) Applicant: QUALCOMM Incorporated, San Diego, CA (US)

(72) Inventors: Yingying Qin, Beijing (CN); Mingchen Gao, Beijing (CN); Xiaocheng Wang, Beijing (CN)

(21) Appl. No.: 18/040,504

(22) PCT Filed: Oct. 27, 2020
(86) PCT No.: PCT/CN2020/123866

§ 371 Date: Feb. 3, 2023

(51) Int. Cl. H04N 25/61; H04N 23/63; G06V 40/16; G06T 3/00; G06T 5/20; G06T 5/00; H04N 23/88

(52) U.S. Cl. CPC H04N 25/61; G06T 3/0018; G06T 5/006; G06T 5/20; G06V 40/166; H04N 23/632; H04N 23/88

(57) ABSTRACT

A processor may be configured to receive an image having lens distortion from a camera module and may determine one or more configuration settings from the image based on the lens distortion. In some examples, the processor may perform lens distortion correction on the image prior to determining the one or more configuration settings. In other examples, the processor may determine configuration settings based on distorted grid cells of the image having lens distortion, wherein the distorted grid cells are defined by the lens distortion. In other examples, the processor may determine initial configuration statistics values from the image having the lens distortion and then adjust the initial configuration statistics values based on the lens distortion.

### TECHNICAL FIELD

The disclosure relates to image capture and processing.

### BACKGROUND

Image capture devices are incorporated into a wide variety of devices. In this disclosure, an image capture device refers to any device that can capture one or more digital images, including devices that can capture still images and devices that can capture sequences of images to record video. By way of example, image capture devices may comprise stand-alone digital cameras or digital video camcorders, camera-equipped wireless communication device handsets, such as mobile telephones having one or more cameras, cellular or satellite radio telephones, camera-equipped personal digital assistants (PDAs), panels or tablets, gaming devices, computer devices that include cameras, such as so-called “web-cams,” or any devices with digital imaging or video capabilities.

Image capture devices may be capable of producing imagery under a variety of lighting conditions (e.g., illuminants). For example, image capture devices may operate in environments that include large amounts of reflected or saturated light, as well as in environments that include high levels of contrast. Some example image capture devices include an adjustment module for exposure control, white balance, and focus, in addition to other modules (e.g., a tint adjustment module), to adjust the processing performed by image signal processor (ISP) hardware.

An image capture device may allow a user to manually select image sensor and image processing configuration parameters, including exposure control, white balance, and focus and focus settings. By manually selecting the configuration parameters, the user may select settings appropriate for current environmental conditions to better capture images in that environment. Alternatively, or additionally, image capture devices may include processing techniques for automatically determining such configuration settings. Automatic exposure control, automatic white balance, and automatic focus techniques are sometimes collectively called 3A settings.

### SUMMARY

In general, this disclosure describes techniques for image processing. In particular, this disclosure describes techniques for determining one or more configuration settings (e.g., automatic exposure control, automatic focus, and/or automatic white balance settings) for a camera, in a manner that takes into account lens distortion in an acquired image. For some camera modules, particularly those with wide angle lenses, images acquired by such camera modules may exhibit lens distortion. In some examples, lens distortion may cause features of the image in some regions (e.g., corner regions of the image) to occupy a smaller size in the acquired image than what can be seen with the human eye. In addition, the lens distortion may cause features of the image in some regions (e.g., corner regions) to occupy a different size than features in different regions (e.g., center regions). This phenomenon may be referred to as the different occupied size problem.

Image processing devices may perform a lens distortion correction process on acquired images to remove distortion effects. However, processing techniques for determining configuration settings (e.g., statistics processing techniques) are typically performed on the image having lens distortion. Determining configuration settings on the image having the lens distortion may cause such configuration settings to be less accurate than optimal. This loss in accuracy may be particularly noticeable in situations where configuration settings are determined from image statistics in regions of the image that are distorted.

In some examples, a user may indicate a particular region-of-interest (ROI) in the acquired image on which to determine one or more configuration settings. For example, a user may indicate an ROI for determining a focus point, including touching a desired region on a preview image displayed on a touchscreen of the image processing device. The image processing device typically performs lens distortion correction before displaying preview images. As such, the ROI indicated by a user touching the preview image may not be the same region as in the acquired image on which statistics processing is performed, because the image on which statistics processing is performed may exhibit lens distortion in the indicated ROI. As such, any configuration settings determined from the indicated ROI may not match user expectations, and thus may result in inaccurate configuration settings.

In accordance with the techniques of this disclosure, a processor may be configured to receive an image having lens distortion from an image sensor and may determine one or more configuration settings from the image based on the lens distortion. In some examples, the processor may perform lens distortion correction on the image prior to determining the one or more configuration settings. In other examples, the processor may determine configuration settings based on distorted grid cells of the image having lens distortion, wherein the distorted grid cells are defined by the lens distortion. In other examples, the processor may determine initial configuration statistics values from the image having the lens distortion and then adjust the initial configuration statistics values based on the lens distortion. The processor may then determine the configuration settings from the adjusted configuration statistics values.

In one example, this disclosure describes an apparatus configured for camera processing, the apparatus comprising a memory configured to store one or more images, and one or more processors in communication with the memory, the one or more processors configured to receive, via an image sensor, an image having lens distortion, determine one or more configuration settings from the image based on the lens distortion, and acquire a subsequent image using the one or more configuration settings.

In another example, this disclosure describes a method of camera processing, the method comprising receiving, via an image sensor, an image having lens distortion, determining one or more configuration settings from the image based on the lens distortion, and acquiring a subsequent image using the one or more configuration settings.

In another example, this disclosure describes a non-transitory computer-readable storage medium storing instructions that, when executed, cause one or more processors of a device for camera processing to receive, via an image sensor, an image having lens distortion, determine one or more configuration settings from the image based on the lens distortion, and acquire a subsequent image using the one or more configuration settings.

In another example, this disclosure describes an apparatus configured for camera processing, the apparatus comprising means for receiving, via an image sensor, an image having lens distortion, means for determining one or more configuration settings from the image based on the lens distortion, and means for acquiring a subsequent image using the one or more configuration settings.

The details of one or more examples are set forth in the accompanying drawings and the description below. Other features, objects, and advantages will be apparent from the description, drawings, and claims.

### BRIEF DESCRIPTION OF DRAWINGS

FIG. 1 is a block diagram of a device configured to perform one or more of the example techniques described in this disclosure.

FIG. 2 is a conceptual diagram showing an example of an image with lens distortion and a corrected image.

FIG. 3 is a conceptual diagram showing an example of regions of an image with a different occupied size due to lens distortion.

FIG. 4 is a conceptual diagram showing an example regions-of-interest with a different occupied size due to lens distortion.

FIG. 5 is a block diagram showing an example of statistics processing based on lens distortion in accordance with the techniques of the disclosure.

FIG. 6 is a conceptual diagram showing a grid that models lens distortion.

FIG. 7 is a conceptual diagram showing an inverse grid used to perform lens distortion correction.

FIG. 8 is a block diagram showing another example of statistics processing based on lens distortion in accordance with the techniques of the disclosure.

FIG. 9 is a conceptual diagram showing an example of a distorted grid used for statistics processing in accordance with one example of the disclosure.

FIG. 10 is a block diagram showing another example of statistics processing based on lens distortion in accordance with the techniques of the disclosure.

FIG. 11 is a conceptual diagram illustrating an example of region-of-interest selection based on lens distortion.

FIG. 12 is a conceptual diagram illustrating another example of region-of-interest selection based on lens distortion.

FIG. 13 is a flowchart illustrating an example method of the disclosure.

FIG. 14 is a flowchart illustrating another example method of the disclosure.

FIG. 15 is a flowchart illustrating another example method of the disclosure.

FIG. 16 is a flowchart illustrating another example method of the disclosure.

### DETAILED DESCRIPTION

For some camera modules, particularly those using wide angle lens, the acquired images may exhibit lens distortion. In general, lens distortion is any deviation from an expected rectilinear projection. That is, lens distortion may cause expected straight lines in a scene to be non-straight. The amount and type of lens distortion typically depends on the shape and type of lens used to acquire the image. Common examples of lens distortion include barrel distortion, pincushion distortion, and mustache distortion.

For images exhibiting barrel distortion, the magnification of regions of the image decrease with distance from the center. For example, regions in the center of an image will appear larger relative to regions in the corners of the image. Barrel distortion may be caused by wide angle lenses, including fisheye lenses. For images exhibiting pincushion distortion, the magnification of regions of the image increases with distance from the center. For example, regions in the center of an image will be smaller relative to regions in the corners of the image. Pincushion distortion may be present in lenses with long-range zoom capabilities. Mustache distortion (also called complex distortion), includes features of both barrel distortion and pincushion distortion. Mustache distortion most often occurs at the wide end of zoom ranges on lenses having optical zoom capabilities.

Some image signal processors (ISPs) use lens distortion correction techniques to correct for lens distortion present in an acquired image. After the ISP performs lens distortion correction, the corrected image is undistorted, and the field-of-view (FOV) of the corrected image is different than the original raw image having the lens distortion. In addition to performing lens distortion correction on acquired images, ISPs may also determine configuration settings. In this disclosure, configuration settings may include one or more of an automatic focus (“auto focus”) setting, an auto exposure control setting, and/or an auto white balance setting. The techniques of this disclosure may be applicable for use with other configuration settings related to camera processing, including configuration settings and/or processing techniques related to object and/or face detection. The ISP may determine the configuration settings, including performing statistics processing on features of an acquired image. The determined configuration settings may then be used to acquire subsequent images.

While the ISP may perform lens distortion correction on the original raw image for preview display and/or storage, the ISP determines configuration settings on the original raw image having the lens distortion. Accordingly, in some examples, the determined configuration settings may lack precision. This lack of precision may be particularly noticeable in so-called touch region-of-interest (ROI) use cases. In a touch ROI use case, a user indicates a portion of an image on which to determine one or more configuration settings (e.g., indicating a region for auto focus and/or a region to optimize and/or prioritize exposure). In some examples, the user may indicate the ROI, including touching a portion of display showing a preview image. As described above, the ISP may have performed lens distortion correction on the acquired image prior to preview display. As such, the ROI of the corrected image indicated by the user may not map directly to a region of the original raw image having the lens distortion from which the ISP determines the configuration settings.

The techniques of this disclosure may be applicable with other ROI-based techniques for determining configuration settings of a camera. That is, the ROIs may not necessarily be manually input by the user touching a portion of a preview image. In one example, ROI may be automatically determined. For example, the ROI may be based on face detection, objection detection, or other modes of determining configuration settings that use one or more ROIs of an image that are a subset of the entire image (e.g., a spot metering automatic exposure control technique). In addition, an ROI may be determined from a user input that is different than touch, such as a hand gesture, eye gaze tracking, voice command, or other inputs.

In view of these drawbacks, this disclosure describes devices and techniques for determining configuration settings based on lens distortion that may be present in the acquired image. In one example, an ISP may perform lens distortion correction on an acquired image before determining configuration settings. That is, the ISP may determine configuration settings on an image on which the lens distortion has been corrected. In another example, the ISP may determine configuration settings using a distorted grid based on the lens distortion. In this way, lens distortion is accounted for when determining the configuration settings. In another example, the ISP may first determine initial configuration statistics values on an original image having the lens distortion, and then perform post-processing techniques on the initial configuration statistics values based on lens distortion. The techniques of this disclosure may improve the accuracy of configuration settings determined from acquired images having lens distortion, including configuration settings determined from ROIs of an image (e.g., touch ROIs indicated by a user).

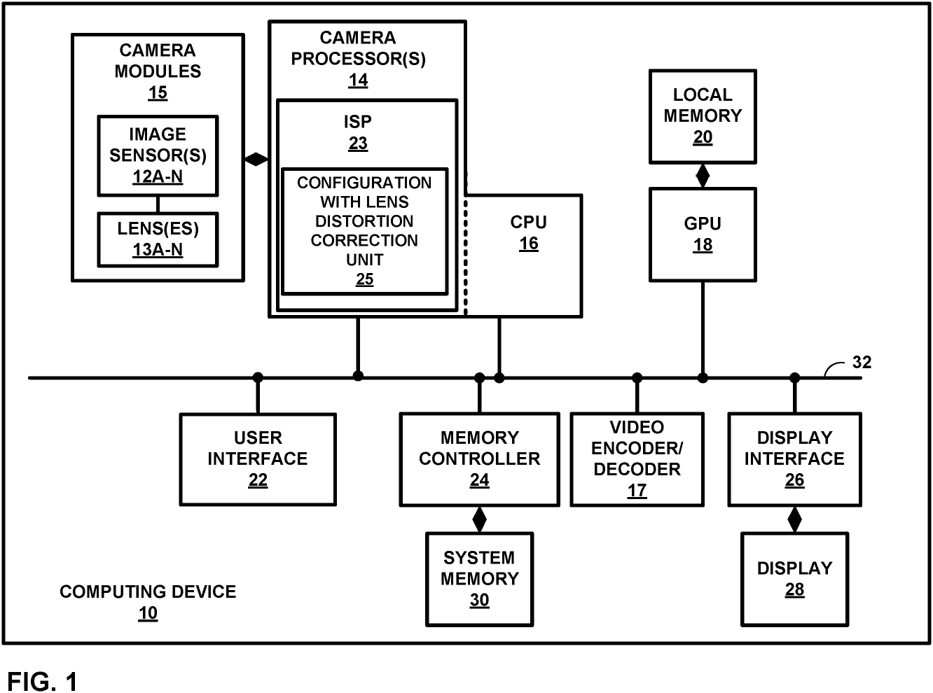

FIG. 1 is a block diagram of a computing device 10 configured to perform one or more of the example techniques described in this disclosure for determining configuration settings based on lens distortion. Examples of computing device 10 include a computer (e.g., personal computer, a desktop computer, or a laptop computer), a mobile device such as a tablet computer, a wireless communication device (such as, e.g., a mobile telephone, a cellular telephone, a satellite telephone, and/or a mobile telephone handset), an Internet telephone, a digital camera, a digital video recorder, a handheld device, such as a portable video game device or a personal digital assistant (PDA), a drone device, or any device that may include one or more cameras. In some examples, computing device 10 may include one or more camera processor(s) 14, a central processing unit (CPU) 16, a video encoder/decoder 17, a graphics processing unit (GPU) 18, local memory 20 of GPU 18, user interface 22, memory controller 24 that provides access to system memory 30, and display interface 26 that outputs signals that cause images and/or graphical data to be displayed on display 28.

As illustrated in the example of FIG. 1, computing device 10 includes one or more image sensor(s) 12A-N. Image sensor(s) 12A-N may be referred to in some instances herein simply as “sensor 12,” while in other instances may be referred to as a plurality of “sensors 12” where appropriate. Sensors 12 may be any type of image sensor, including sensors that include a Bayer filter, or high-dynamic range (HDR) interlaced sensors, such as a Quad-Bayer sensor.

Computing device 10 further includes one or more lens(es) 13A-N. Similarly, lens(es) 13A-N may be referred to in some instances herein simply as “lens 13,” while in other instances may be referred to as a plurality of “lenses 13” where appropriate. In some examples, sensor(s) 12 represent one or more image sensors 12 that may each include processing circuitry, an array of pixel sensors (e.g., pixels) for capturing representations of light, memory, such as buffer memory or on-chip sensor memory, etc. In some examples each of image sensors 12 may be coupled with a different type of lens 13, each lens and image sensor combination having different apertures and/or fields-of-view. Example lenses may include a telephoto lens, a wide angle lens, an ultra-wide angle lens, or other lens types.

As shown in FIG. 1, computing device 10 includes multiple camera modules 15. As used herein, the term “camera module” refers to a particular image sensor 12 of computing device 10, or a plurality of image sensors 12 of computing device 10, where the image sensor(s) 12 are arranged in combination with one or more lens(es) 13 of computing device 10. That is, a first camera module 15 of computing device 10 refers to a first collective device that includes one or more image sensor(s) 12 and one or more lens(es) 13, and a second camera module 15, separate from the first camera module 15, refers to a second collective device that includes one or more image sensor(s) 12 and one or more lens(es) 13. In addition, image data may be received from image sensor(s) 12 of a particular camera module 15 by camera processor(s) 14 or CPU 16. That is, camera processor(s) 14 or CPU 16 may, in some examples, receive a first set of frames of image data from a first image sensor 12 of a first camera module 15 and receive a second set of frames of image data from a second image sensor 12 of a second camera module 15.

In an example, the term “camera module” as used herein refers to a combined image sensor 12 and lens 13 that, coupled together, are configured to capture at least one frame of image data and transfer the at least one frame of the image data to camera processor(s) 14 and/or CPU 16. In an illustrative example, a first camera module 15 is configured to transfer a first frame of image data to camera processor(s) 14 and a second camera module 15 is configured to transfer a second frame of image data to camera processor(s) 14, where the two frames are captured by different camera modules as may be evidenced, for example, by the difference in FOV and/or zoom level of the first frame and the second frame. The difference in FOV and/or zoom level may correspond to a difference in focal length between the first camera module 15 and the second camera module 15.

Computing device 10 may include dual lens devices, triple lens devices, 360-degree camera lens devices, etc. As such, each lens 13 and image sensor 12 combination may provide various zoom levels, angles of view (AOV), focal lengths, fields of view (FOV), etc. In some examples, particular image sensors 12 may be allocated for each lens 13, and vice versa. For example, multiple image sensors 12 may be each allocated to different lens types (e.g., wide lens, ultra-wide lens, telephoto lens, and/or periscope lens, etc.).

Camera processor(s) 14 may be configured to control the operation of camera modules 15 and perform processing on images received from camera modules 15. In some examples, camera processor(s) 14 may include an image signal processor (ISP) 23. For instance, camera processor(s) 14 may include circuitry to process image data. Camera processor(s) 14, including ISP 23, may be configured to perform various operations on image data acquired by image sensors 12, including lens distortion correction, white balance adjustment, color correction, or other post-processing operations. FIG. 1 shows a single ISP 23 configured to operate on the output of camera modules 15. In other examples, camera processor(s) 14 may include an ISP 23 for each of camera modules 15 in order to increase processing speed and/or improve synchronization for simultaneous image capture from multiple camera modules of camera modules 15.

In some examples, camera processor(s) 14 are configured to receive image frames (e.g., pixel data) from image sensor(s) 12, and process the image frames to generate image and/or video content. For example, image sensor(s) 12 may be configured to capture individual frames, frame bursts, frame sequences for generating video content, photo stills captured while recording video, preview frames, or motion photos from before and/or after capture of a still photograph. CPU 16, GPU 18, camera processor(s) 14, or some other circuitry may be configured to process the image and/or video content captured by sensor(s) 12 into images or video for display on display 28. Image frames may generally refer to frames of data for a still image or frames of video data or combinations thereof, such as with motion photos. Camera processor(s) 14 may receive from sensor(s) 12 pixel data of the image frames in any format. For example, the pixel data may include different color formats, such as RGB, YCbCr, YUV, etc. In any case, camera processor(s) 14 may receive, from image sensor(s) 12, a plurality of frames of image data.

In examples including multiple camera processor(s) 14, camera processor(s) 14 may share sensor(s) 12, where each of camera processor(s) 14 may interface with each of sensor(s) 12. In any event, camera processor(s) 14 may initiate capture of a video or image of a scene using a plurality of pixel sensors of sensor(s) 12. In some examples, a video may include a sequence of individual frames. As such, camera processor(s) 14 causes sensor(s) 12 to capture the image using the plurality of pixel sensors. Sensor(s) 12 may then output pixel information to camera processor(s) 14 (e.g., pixel values, luma values, color values, charge values, Analog-to-Digital Units (ADU) values, etc.), the pixel information representing the captured image or sequence of captured images. In some examples, camera processor(s) 14 may process monochrome and/or color images to obtain an enhanced color image of a scene. In some examples, camera processor(s) 14 may determine universal blending weight coefficient(s) for different types of pixel blending or may determine different blending weight coefficient(s) for blending different types of pixels that make up a frame of pixels (e.g., a first blending weight coefficient for blending pixels obtained via a monochrome sensor of first camera module 15 and pixels obtained via a monochrome sensor of second camera module 15, a second blending weight coefficient for blending pixels obtained via a Bayer sensor of first camera module 15 and pixels obtained via a Bayer sensor of second camera module 15, etc.).

ISP 23 of camera processor(s) 14 may also be configured to determine configuration settings (also called “3A” settings). The configuration settings may include settings for auto focus (AF), auto exposure control (AEC), and auto white balance (AWB). The techniques of this disclosure may be applicable for use with other configuration settings related to camera processing, including configuration settings and/or processing techniques related to object detection and/or face detection. In general, the techniques of this disclosure may be used in conjunction with any camera configuration determination and/or processing that may be based on an image having lens distortion. In some examples, ISP 23 may determine the configuration settings, including performing statistics (“stats”) processing on the pixel data of an acquired image. In general, when performing stats processing, ISP 23 may divide an acquired image into cells of size MxN, where M and N represent a number of pixels. ISP 23 may accumulate statistics, per cell, for certain image characteristics that are applicable for determining configuration settings.

As one example, ISP 23 may determine auto focus settings for camera module 15. The auto focus setting may include an indication of a lens position. ISP 23 may determine, from one or more images acquired from camera module 15, a lens position that produces an optimal focus and then sends an indication of that lens position to camera module 15. Camera module 15 may then set the position of lens 13 based on the indicated lens position and acquire subsequent images. ISP 23 may use any techniques of determining lens position, including contrast detection auto focus, phase detection auto focus, time-of-flight (ToF) auto focus, laser auto focus, or any combination of auto focus techniques (e.g., hybrid auto focus techniques).

In some examples, ISP 23 may determine auto focus settings from pixel data of the entire image. In other examples, ISP 23 may determine auto focus settings from pixel data in a center region of the image. In still other examples, ISP 23 may determine auto focus settings from a specific ROI of an image. In some examples, the ROI may be automatically determined by camera processor(s) 14 (e.g., using object tracking or other techniques). In other examples, the ROI may be indicated by a user. For example, the user indication may include touching an area of a preview image. For contrast auto focus, ISP 23 may perform statistics processing on one or more acquired images, the statistics processing including analyzing contrast-based focus values for certain regions of an image. The contrast-based focus value may include both horizontal and vertical focus values, which indicate the intensity difference between adjacent pixels in image sensor 12. In general, the intensity difference between adjacent pixels increases with optimal image focus. In other words, more blurry areas of an image tend to have more similar intensity values in neighboring pixels.

For phase detection auto focus, ISP may ISP 23 may perform statistics processing on one or more acquired images, the statistics processing including analyzing phase-based focus values for certain regions of an image. In some examples, image sensor 12 may include dual photodiode, where incoming light hits two portions of a single pixel sensor. ISP 23 may be configured to measure the phase difference between the two sides of a single dual photodiode sensor.

As another example, ISP 23 may determine auto exposure control settings for camera module 15. Auto exposure control settings may include a shutter speed and/or an aperture size. In some examples, ISP 23 may determine both the shutter speed and an aperture size based on statistics of an image. In other examples, a user may set the shutter speed and ISP 23 may determine the aperture size from the predetermined shutter speed and the statistics of the image (e.g., in shutter priority auto exposure). In still other examples, a user may set the aperture size and ISP 23 may determine the shutter speed from the predetermined aperture size and the statistics of the image (e.g., in aperture priority auto exposure). ISP 23 may then send the auto exposure control settings to camera module 15 and camera module 15 may acquire subsequent images using the auto exposure control settings.

In general, when determining auto exposure control settings, ISP 23 may be configured to accumulate and analyze brightness values of image data. ISP 23 may determine the shutter speed and/or aperture size such that the brightness levels present in an image are centered around a mid-level of the total brightness levels able to be detected. That is, ISP 23 generally determines auto exposure control settings to limit the number of over exposed and under exposed areas in an image. When analyzing an image for auto exposure control, ISP 23 may operate in one of a plurality of metering modes, including a spot metering mode, a center-weighted average metering mode, an average metering mode, a partial metering mode, a multi-zone metering mode, or a highlight-weighted metering mode. However, the techniques of this disclosure are applicable for use with any type of metering mode used for determining auto exposure control settings.

In some metering modes, such as average metering, ISP 23 will analyze brightness statistics of an entire image to determine auto exposure control settings. In other metering modes, such as multi-zone metering, ISP 23 will analyze brightness statistics in multiple regions across the image. In center-weighted average metering, ISP 23 will more strongly weight the brightness statistics in the center of the image to determine auto exposure control settings.

In a spot metering mode, ISP 23 will analyze brightness statistics in a particular ROI of the image. Again, as with auto focus, the ROI for determining auto exposure control settings may be automatically determined or may be indicated by a user. For example, in some digital cameras, a user may touch on regions of a preview image to change the auto exposure control settings. In general, ISP 23 will optimize the auto exposure control settings for the brightness levels present in the ROI indicated by the user. As such, if a user touches a relatively dark area of a preview image being displayed, ISP 23 will determine auto exposure control settings that brightens a subsequently acquired image relative to the preview image. If a user touches a relatively bright area of a preview image being displayed, ISP 23 will determine auto exposure control settings that darkens a subsequently acquired image relative to the preview image.

As another example, ISP 23 may determine auto white balance settings (e.g., an auto white balance gain) for images acquired from camera module 15. White balance (sometimes called color balance, gray balance or neutral balance) refers to the adjustment of relative amounts of primary colors (e.g., red, green and blue) in an image or display such that neutral colors are reproduced correctly. White balance may change the overall mixture of colors in an image. Without white balance, the display of captured images may contain undesirable tints. In general, when performing auto white balance techniques, ISP 23 may determine the color temperature of the illuminant under which an image was captured, including analyzing the colors and gray tones present in the acquired image. ISP 23 may then output an auto white balance gain (e.g., the auto white balance setting) that may be applied to subsequently acquired images. In some examples, ISP 23 may apply the determined auto white balance gain to acquired images as a post-processing technique. In other examples, ISP 23 may send the white balance gain to camera module 15 and image sensor 12 may apply the white balance gain. The above descriptions of configuration settings are just examples. The techniques of this disclosure may be applicable for use with any techniques for determining configuration settings.

As described above, some camera processing systems use lens distortion correction to techniques to correct for any the lens distortion present in an acquired image. While the such camera processing systems may perform lens distortion correction on the original raw image for preview display and/or storage, the camera processing system may determine configuration settings on the original raw image having the lens distortion. Accordingly, in some examples, the determined configuration settings may lack precision. This lack of precision may be particularly noticeable in configuration settings determined from ROIs that are in more distorted areas of an image. In a touch ROI use case, a user indicates a portion of an image on which to determine one or more configuration settings (e.g., indicating a region for auto focus and/or a region to optimize exposure). In some examples, the user may indicate the ROI, including touching a portion of display showing a preview image. As described above, the camera processing systems may have performed lens distortion correction on the acquired image prior to preview display. As such, the ROI of the corrected image indicated by the user may not map directly to a region of the original raw image having the lens distortion from which the camera processing systems determines the configuration settings.

In view of these drawbacks, this disclosure describes devices and techniques for determining configuration settings based on lens distortion that may present in the acquired image. In one example, ISP 23 may include configuration with lens distortion correction unit 25. In general, configuration with lens distortion correction unit 25 determines configuration settings in a manner that accounts for any lens distortion present in the image being analyzed. In one example, configuration with lens distortion correction unit 25 may perform lens distortion correction on an acquired image before determining configuration settings. That is, configuration with lens distortion correction unit 25 may determine configuration settings on an image on which the lens distortion has been corrected. In another example, configuration with lens distortion correction unit 25 may determine configuration settings using a distorted grid based on the lens distortion. In this way, lens distortion is accounted for when determining the configuration settings. In another example, configuration with lens distortion correction unit 25 may first determine initial configuration statistics values on an original image having the lens distortion, and then perform post-processing techniques on the initial configuration statistics values based on lens distortion. The techniques of this disclosure may improve the accuracy of configuration settings determined from acquired images having lens distortion, including configuration settings determined from ROIs of an image (e.g., ROIs indicated by a user and/or automatically determined ROIs).

Accordingly, in one example of the disclosure, ISP 23 may be configured to receive, via camera module 15, an image having lens distortion. ISP 23 may determine one or more configuration settings from the image based on the lens distortion, wherein the one or more configuration settings include an auto focus setting, an auto exposure control setting, or an auto white balance setting. ISP 23 may then cause camera module 15 to acquire a subsequent image using the one or more configuration settings.

Although the various structures of computing device 10 are illustrated as separate in FIG. 1, the techniques of this disclosure are not so limited, and in some examples the structures may be combined to form a system on chip (SoC). As an example, camera processor(s) 14, CPU 16, GPU 18, and display interface 26 may be formed on a common integrated circuit (IC) chip. In some examples, one or more of camera processor(s) 14, CPU 16, GPU 18, and display interface 26 may be formed on separate IC chips. Various other permutations and combinations are possible, and the techniques of this disclosure should not be considered limited to the example illustrated in FIG. 1. In an example, CPU 16 may include camera processor(s) 14 such that one or more of camera processor(s) 14 are part of CPU 16. In such examples, CPU 16 may be configured to perform one or more of the various techniques otherwise ascribed herein to camera processor(s) 14. For purposes of this disclosure, camera processor(s) 14 will be described herein as being separate and distinct from CPU 16, although this may not always be the case.

The various structures illustrated in FIG. 1 may be configured to communicate with each other using bus 32. Bus 32 may be any of a variety of bus structures, such as a third-generation bus (e.g., a HyperTransport bus or an InfiniBand bus), a second-generation bus (e.g., an Advanced Graphics Port bus, a Peripheral Component Interconnect (PCI) Express bus, or an Advanced eXtensible Interface (AXI) bus) or another type of bus or device interconnect. It should be noted that the specific configuration of buses and communication interfaces between the different structures shown in FIG. 1 is merely exemplary, and other configurations of computing devices and/or other image processing systems with the same or different structures may be used to implement the techniques of this disclosure.

In addition, the various components illustrated in FIG. 1 (whether formed on one device or different devices), including sensor(s) 12 and camera processor(s) 14, may be formed as at least one of fixed-function or programmable circuitry, or a combination of both, such as in one or more microprocessors, application specific integrated circuits (ASICs), field programmable gate arrays (FPGAs), digital signal processors (DSPs), or other equivalent integrated or discrete logic circuitry. In addition, examples of local memory 20 include one or more volatile or non-volatile memories or storage devices, such as random-access memory (RAM), static RAM (SRAM), dynamic RAM (DRAM), erasable programmable ROM (EPROM), electrically erasable programmable ROM (EEPROM), flash memory, a magnetic data media or an optical storage media.

In some examples, memory controller 24 may facilitate the transfer of data going into and out of system memory 30. For example, memory controller 24 may receive memory read and write commands, and service such commands with respect to memory 30 in order to provide memory services for various components of computing device 10. In such examples, memory controller 24 may be communicatively coupled to system memory 30. Although memory controller 24 is illustrated in the example of computing device 10 of FIG. 1 as being a processing circuit that is separate from both CPU 16 and system memory 30, in some examples, some or all of the functionality of memory controller 24 may be implemented on one or more of CPU 16, system memory 30, camera processor(s) 14, video encoder/decoder 17, and/or GPU 18.

System memory 30 may store program modules and/or instructions and/or data that are accessible by camera processor(s) 14, CPU 16, and/or GPU 18. For example, system memory 30 may store user applications (e.g., instructions for a camera application), resulting images from camera processor(s) 14, etc. System memory 30 may additionally store information for use by and/or generated by other components of computing device 10. For example, system memory 30 may act as a device memory for camera processor(s) 14. System memory 30 may include one or more volatile or non-volatile memories or storage devices, such as, for example, RAM, SRAM, DRAM, ROM, EPROM, EEPROM, flash memory, a magnetic data media or an optical storage media. In addition, system memory 30 may store image data (e.g., frames of video data, encoded video data, sensor-mode settings, zoom settings, configuration parameters, configuration settings, etc.). In some examples, system memory 30 or local memory 20 may store the image data to on-chip memory, such as in a memory buffer of system memory 30 or local memory 20. In another example, system memory 30 or local memory 20 may output image data in order to be stored external from the memory of a chip or buffer, such as to a secure digital (SD®) card of a camera device or in some instances, to another internal storage of a camera device. In an illustrative example, system memory 30 or local memory 20 may be embodied as buffer memory on a camera processor(s) 14 chip, GPU 18 chip, or both where a single chip includes both processing circuitries.

In some examples, system memory 30 may include instructions that cause camera processor(s) 14, CPU 16, GPU 18, and/or display interface 26 to perform the functions ascribed to these components in this disclosure. Accordingly, system memory 30 may be a computer-readable storage medium having instructions stored thereon that, when executed, cause one or more processors (e.g., camera processor(s) 14, CPU 16, GPU 18, and display interface 26) to perform the various techniques of this disclosure.

In some examples, system memory 30 is a non-transitory storage medium. The term “non-transitory” indicates that the storage medium is not embodied in a carrier wave or a propagated signal. However, the term “non-transitory” should not be interpreted to mean that system memory 30 is non-movable or that its contents are static. As one example, system memory 30 may be removed from computing device 10, and moved to another device. As another example, memory, substantially similar to system memory 30, may be inserted into computing device 10. In certain examples, a non-transitory storage medium may store data that can, over time, change (e.g., in RAM).

In addition, camera processor(s) 14, CPU 16, and GPU 18 may store image data, user interface data, etc., in respective buffers that are allocated within system memory 30. Display interface 26 may retrieve the data from system memory 30 and configure display 28 to display the image represented by the image data, such as via a user interface 22 screen. In some examples, display interface 26 may include a digital-to-analog converter (DAC) that is configured to convert digital values retrieved from system memory 30 into an analog signal consumable by display 28. In other examples, display interface 26 may pass the digital values directly to display 28 for processing.

Computing device 10 may include a video encoder and/or video decoder 17, either of which may be integrated as part of a combined video encoder/decoder (CODEC) (e.g., a video coder). Video encoder/decoder 17 may include a video coder that encodes video captured by one or more camera module(s) 15 or a decoder that can decode compressed or encoded video data. In some instances, CPU 16 and/or camera processor(s) 14 may be configured to encode and/or decode video data, in which case, CPU 16 and/or camera processor(s) 14 may include video encoder/decoder 17.

CPU 16 may comprise a general-purpose or a special-purpose processor that controls operation of computing device 10. A user may provide input to computing device 10 to cause CPU 16 to execute one or more software applications. The software applications that execute on CPU 16 may include, for example, a camera application, a graphics editing application, a media player application, a video game application, a graphical user interface application or another program. For example, a camera application may allow the user to control various settings of camera module 15. The user may provide input to computing device 10 via one or more input devices (not shown) such as a keyboard, a mouse, a microphone, a touch pad or another input device that is coupled to computing device 10 via user interface 22.

One example software application is a camera application. CPU 16 executes the camera application, and in response, the camera application causes CPU 16 to generate content that display 28 outputs. For instance, display 28 may output information such as light intensity, whether flash is enabled, and other such information. The camera application may also cause CPU 16 to instruct camera processor(s) 14 to process the images output by sensor 12 in a user-defined manner. The user of computing device 10 may interface with display 28 (e.g., via user interface 22) to configure the manner in which the images are generated (e.g., with zoom settings applied, with or without flash, focus settings, exposure settings, video or still images, and other parameters).

Display 28 may include a monitor, a television, a projection device, an HDR display, a liquid crystal display (LCD), a plasma display panel, a light emitting diode (LED) array, an organic LED (OLED), electronic paper, a surface-conduction electron-emitted display (SED), a laser television display, a nanocrystal display or another type of display unit. In some examples, display 28 may be a touchscreen. Display 28 may be integrated within computing device 10. For instance, display 28 may be a screen of a mobile telephone handset, a tablet computer, or a laptop. Alternatively, display 28 may be a stand-alone device coupled to computing device 10 via a wired or wireless communications link. For instance, display 28 may be a computer monitor or flat panel display connected to a personal computer via a cable or wireless link. Display 28 may provide preview frames that a user may view to see what is being stored or what an image might look like if camera module 15 were to actually take an image or start recording video. In accordance with the examples described above, a user may touch one or more ROIs of a preview image displayed on display 28 and ISP 23 may determine one or more configuration settings using image data in the indicated ROIs.

The techniques of this disclosure may be applicable with other ROI-based techniques for determining configuration settings of a camera. That is, the ROIs may not necessarily be manually input by the user touching a portion of a preview image. In one example, ROI may be automatically determined. For example, the ROI may be based on face detection, objection detection, or other modes of determining configuration settings that use one or more ROIs of an image that are a subset of the entire image (e.g., a spot metering mode for auto exposure). In addition, an ROI may be determined from a user input that is different than touch, such as a hand gesture, eye gaze tracking, voice command, or other inputs.

In one example, camera processor(s) 14 may be configured to perform on ROI detection process on an image. The ROI detection may be a face detection process, an objection detection process, an object tracking process, or any other process for determining an ROI of an image for which to prioritize or optimize camera configuration settings. In one example, camera processor(s) 14 may be configured to receive an input indicating the ROI of an image from a face detection process and determine configuration settings for a camera module using the indicated ROI.

In some examples, camera processor(s) 14 may output a flow of frames to memory controller 24 in order for the output frames to be stored as a video file. In some examples, memory controller 24 may generate and/or store the output frames in any suitable video file format. In some examples, video encoder/decoder 17 may encode the output frames prior to CPU 16, video encoder/decoder 17, and/or camera processor(s) 14 causing the output frames to be stored as an encoded video. Encoder/decoder 17 may encode frames of image data using various encoding techniques, including those described in standards defined by MPEG-2, MPEG-4, ITU-T H.263, ITU-T H.264/MPEG-4, Part 10, Advanced Video Coding (AVC), ITU-T H.265/High Efficiency Video Coding (HEVC), Versatile Video Coding (VCC), etc., and extensions thereof. In a non-limiting example, CPU 16, video encoder/decoder 17, and/or camera processor(s) 14 may cause the output frames to be stored using a Moving Picture Experts Group (MPEG) video file format.

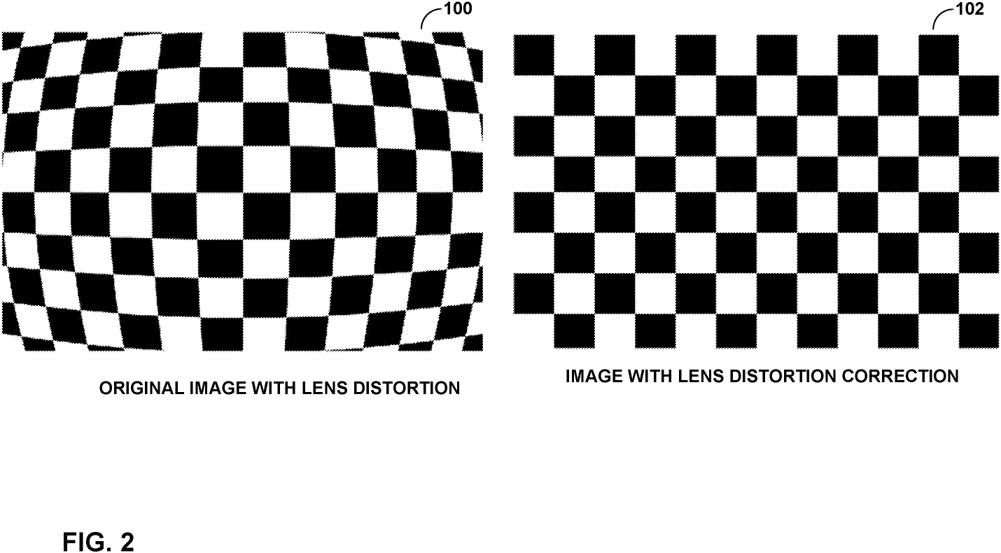

FIG. 2 is a conceptual diagram showing an example of an image with lens distortion and a corrected image. As shown in FIG. 2, image 100 is an original image acquired by camera module 15 that has lens distortion. Image 100 shows an example of barrel distortion, which may be present in the example where lens 13 is a wide angle lens. Image 102 is a corrected image that results from ISP 23 applying lens distortion correction to image 100.

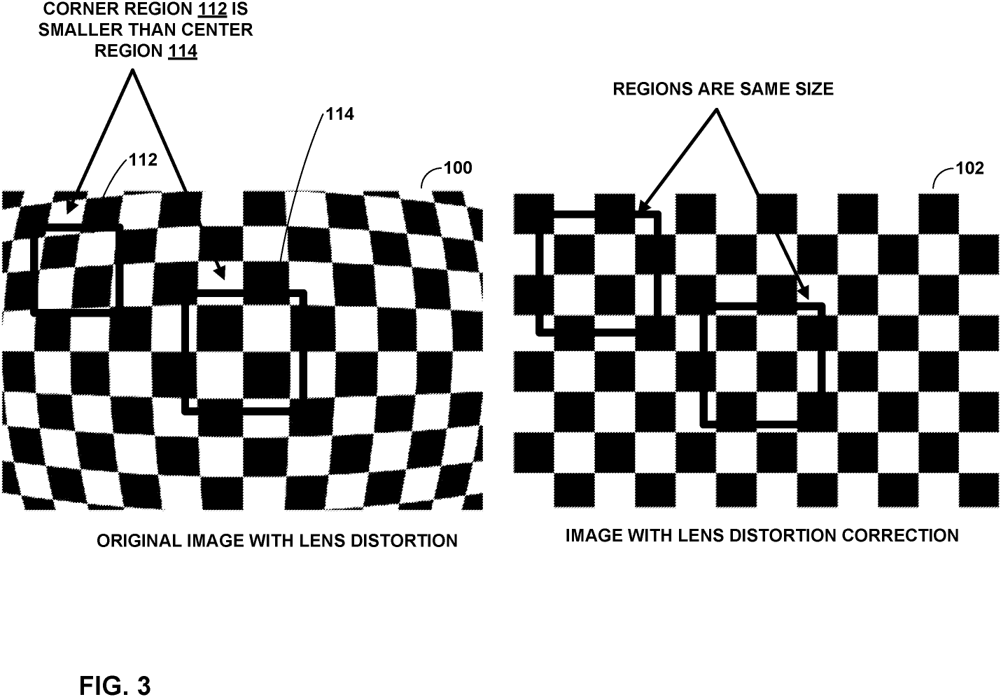

FIG. 3 is a conceptual diagram showing an example of regions of an image with a different occupied size due to lens distortion. As can be seen in FIG. 3, image 100 having the barrel lens distortion results in features in corner regions 112 of image 100 having a smaller size (e.g., using fewer pixels) relative to identical features in the center region 114 of image 100. In FIG. 3, the identical features are the patterns of black and white squares. In an image having no lens distortion, each of these squares would be the same size. This can be seen in corrected image 102. After ISP 23 applies lens distortion correction to image 100, identical features in all regions of corrected image 102 are the same size or approximately the same size. Because identical features in different regions of image 100 occupy different sizes of the image, the statistics of the pixel data in the image vary with position, particularly in the more distorted areas of the image. As such, determining configuration settings from such an image may lead to a decrease in accuracy of such determined configuration settings.

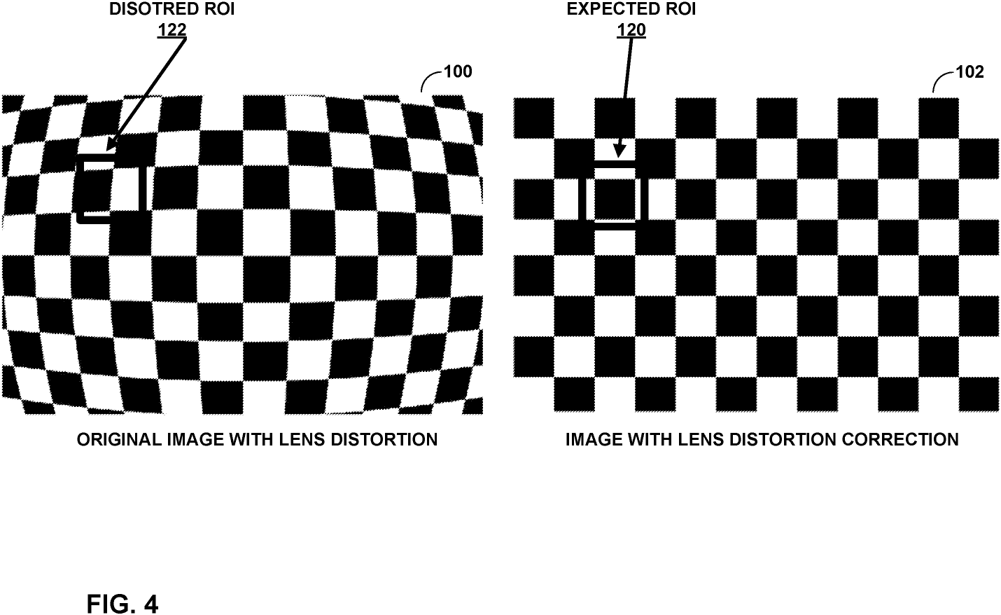

A lack of precision in determined configuration settings may be particularly noticeable when configuration settings are determined from an ROI in a distorted area of an image. FIG. 4 is a conceptual diagram showing an example ROIs with a different occupied size due to lens distortion. In one example, a user may indicate a desired ROI on which to determine one or more configuration settings. For example, a user may indicate an area of a preview image on which to determine an auto focus setting and/or an auto exposure control setting. As described above, the user may indicate the ROI, e.g., including touching a region on an image displayed by display 28 (e.g., touching an area on a touchscreen). In other examples, the user input of an ROI may be based on hand gestures, eye gaze tracking, voice commands, or other input methods. In addition, in some examples, camera processor(s) 14 may automatically determine an ROI, e.g., using face detection, objection detection, or other techniques for determining an ROI on which to prioritize and/or optimize the determination of configurations settings.

FIG. 4 shows an example expected ROI 120 indicated by the user in corrected image 102 because computing device 10 may display a preview image after ISP 23 performs lens distortion correction. However, expected ROI 120 maps to distorted ROI 122 in the original image 100 having lens distortion. That is, distorted ROI 122 is in a region of image 100 that has lens distortion. As such, the features and pixel data in distorted ROI 122 do not match the features and pixel data in expected ROI 120 that were indicated by the user. Accordingly, any configuration settings determined from the data in distorted ROI 122 may result in a less than accurate and/or undesired configuration setting.

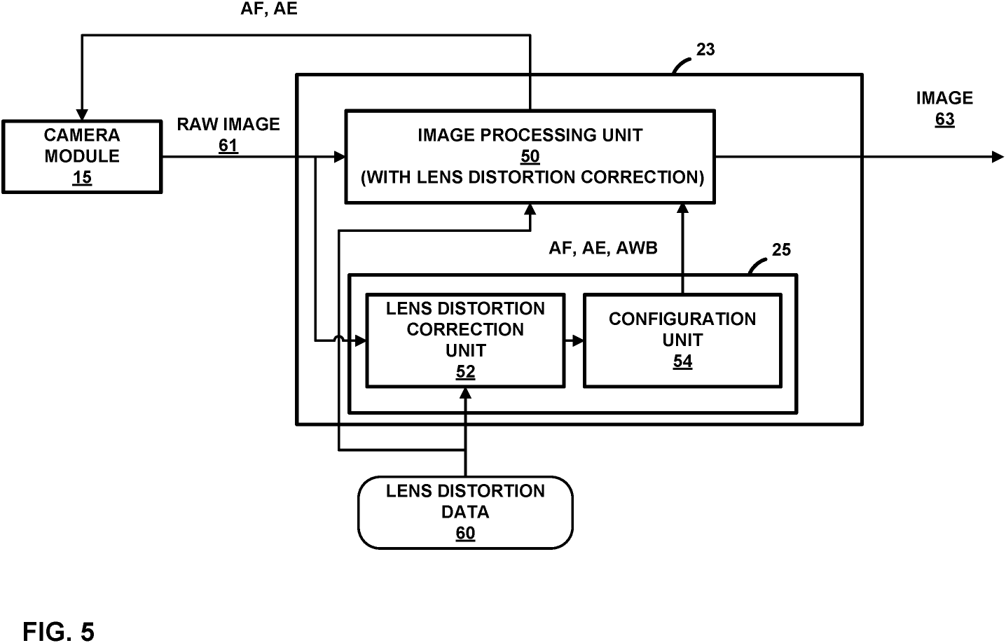

FIG. 5 is a block diagram showing an example of configuration statistics processing based on lens distortion in accordance with the techniques of the disclosure. In the example of FIG. 5, ISP 23 receives a raw image 61 acquired by camera module 15. Raw image 61 may exhibit lens distortion based on the lens 13 used by camera module 15 to acquire raw image 61. The type and amount of lens distortion may be specific to each lens 13 available for use with camera modules 15 of computing device 10. In addition, the type and amount of lens distortion may be specific to the optical zoom setting of the particular lens 13 used to capture raw image 61. In some examples, computing device 10 may include lens distortion data 60 that indicates the type and amount of lens distortion that will be present for one or more lenses and/or optical zoom settings of camera module 15.

The type of lens distortion (e.g., barrel distortion, pincushion distortion, mustache distortion, etc.) and the amount of distortion depends on the particular characteristics of camera module 15, such as the FOV of lens 13. This means that the image processing unit 50 may perform lens distortion correction that is particular to camera module 15. Lens distortion data 60 may be calibrated in an offline process and computing device 10 may store lens distortion data 60 in a memory accessible by ISP 23. In some examples, lens distortion data 60 may be in the form of distortion grids. The distortion grid may include a plurality of vertices where each vertices represents the location of a location in a distorted image (e.g., due to lens distortion) relative to the same location in an image that is not distorted.

ISP 23 includes image processing unit 50 and configuration with lens distortion correction unit 25. As described above in FIG. 1, image processing unit 50 of ISP 23 may perform any number of image processing techniques on raw image 61, including lens distortion correction, white balance adjustment, color correction, or other post-processing operations. In some examples, image processing unit 50 may access lens distortion data 60 to determine the amount and type of lens distortion present in raw image 61 in order to apply appropriate lens distortion correction techniques to raw image 61. In general, image processing unit 50 may perform lens distortion correction as a function of an inverse distortion grid, where the inverse distortion grid is an inverse of the lens distortion produced by camera module 15. As more specific examples, image processing unit 50 may perform one or more of a nearest-neighboring interpolation, bilinear interpolation, bicubic interpolation, Lanczos interpolation, edge-preserving interpolation, or any other combination of techniques. Image processing unit 50 may then output image 63, which may be displayed as a preview image on display 28, and/or stored in a memory of computing device 10.

In accordance with the techniques of this disclosure, rather than determining configuration settings from raw image 61, which includes lens distortion, configuration with lens distortion correction unit 25 may correct for any lens distortion in raw image 61 as part of the configuration settings determination process. For example, configuration with lens distortion correction unit 25 may include lens distortion correction unit 52 and configuration unit 54. Lens distortion correction unit 52 may perform lens distortion correction on raw image 61 using the same techniques of image processing unit 50. Configuration unit 54 may then determine the configuration settings (e.g., AF, AE, and or AWB) from the corrected image. Configuration unit 54 may use any of the techniques described above with reference to FIG. 1. Configuration unit 54 may send AF and AE settings to camera module 15. Camera module 15 may use the AF and AE settings to acquire subsequent images. Configuration unit 54 may also send AWB settings (e.g., an AWB gain) to image processing unit 50. Image processing unit 50 may use the AWB settings to apply an AWB gain to subsequently acquired images.

Accordingly, in one example of the disclosure, to determine the one or more configuration settings, ISP 23 is configured to perform lens distortion correction on the image having the lens distortion to create a corrected image, and determine the one or more configuration settings from the corrected image. In one example, to perform lens distortion correction, ISP 23 is configured to determine a distortion grid related to camera module 15, wherein the distortion grid defines the lens distortion produced by lens 13 of camera module 15, determine an inverse grid related to the distortion grid, and perform lens distortion correction on the image as a function of the inverse grid.

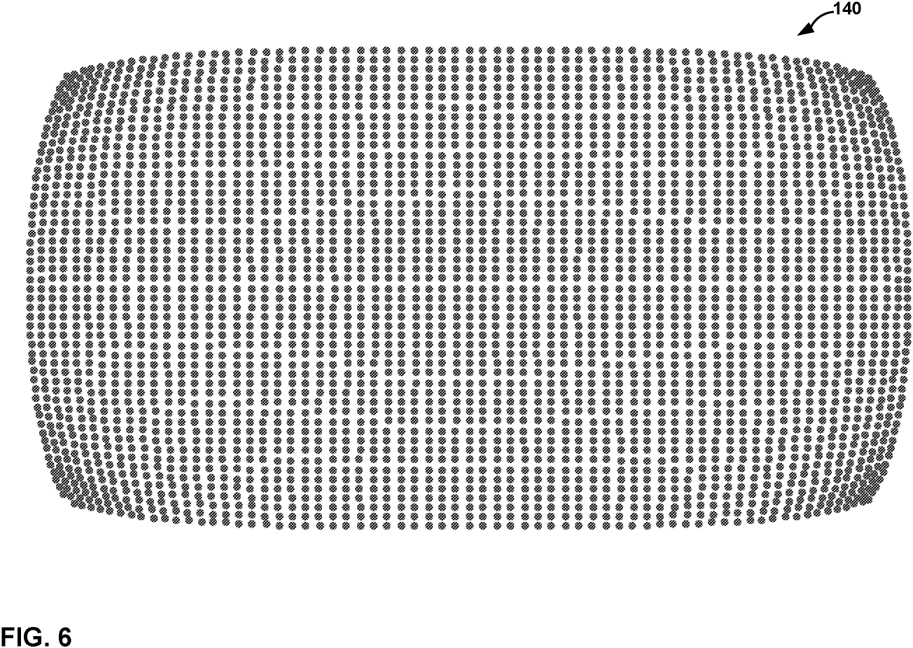

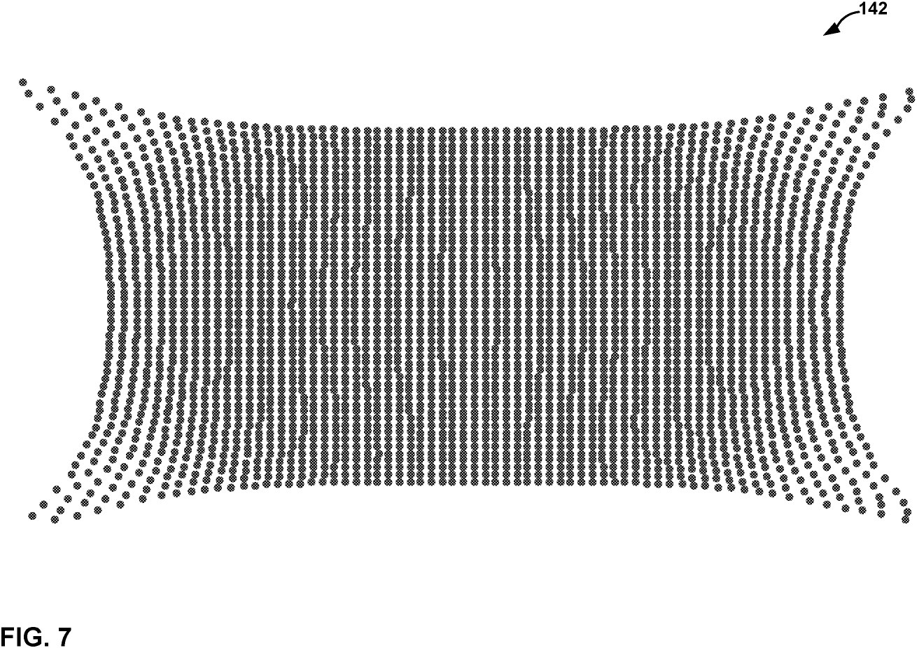

FIG. 6 is a conceptual diagram showing a grid that models lens distortion. In particular, FIG. 6 shows a distortion grid 140 that models one example of barrel distortion. The vertices of distortion grid 140 map a location of pixels of an image with a rectilinear projection (e.g., no distortion) to the location that such pixels will have when captured using a particular lens and zoom setting. FIG. 7 is a conceptual diagram showing an inverse grid used to perform lens distortion correction. Inverse distortion grid 142 is the inverse of distortion grid 140 of FIG. 6. The vertices of inverse distortion grid 142 may move the locations of pixels in a distorted image to locations that such pixels would take to form an image with rectilinear projection (e.g., no distortion). For example, if inverse distortion grid 142 were applied to an image that had lens distortion defined by distortion grid 140, the resulting image would have little to no distortion. Such a lens distortion correction technique may be called grids-based distortion correct.

In grids-based distortion correction, ISP 23 would obtain inverse distortion grid 142, which is the inverse of distortion grid 140, from lens distortion data 60 (see FIG. 5). ISP 23 would then perform lens distortion correction on the distorted image using a function of the inverse grid. That is, Image_undistorted(x, y)= Image_distorted (fx(x,y), fy(xy)), where Image_distorted (x,y) is the position of pixels in the corrected image after lens distortion correction, Image_distorted (x,y) is the position of pixels in the raw image 61, and fx(x,y), fy(xy) are a mapping function based on the location of the grid vertices in inverse distortion grid 142.

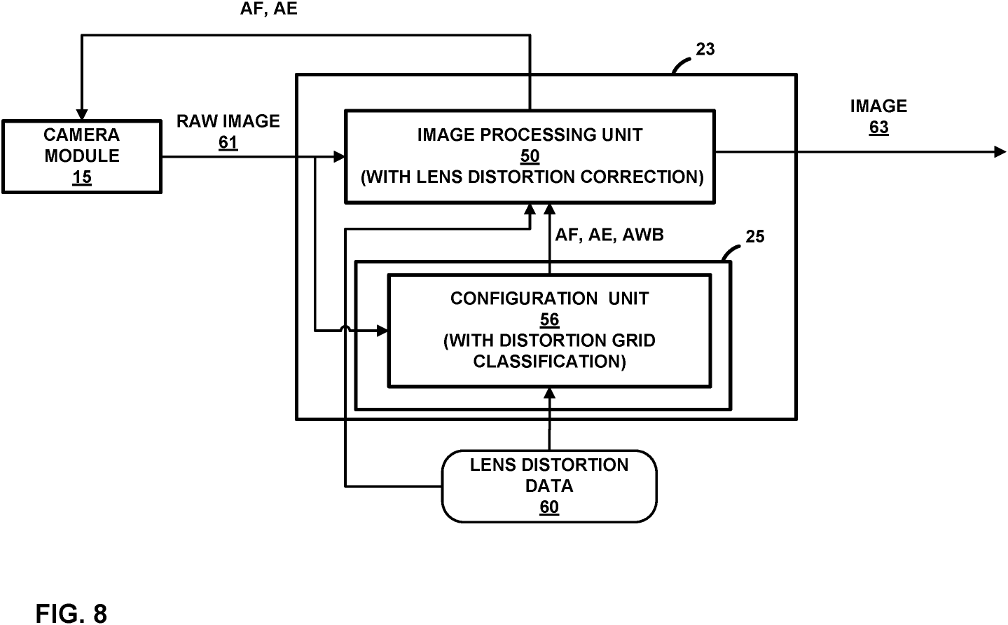

FIG. 8 is a block diagram showing another example of configuration statistics processing based on lens distortion in accordance with the techniques of the disclosure. In the example of FIG. 8, ISP 23 again receives a raw image 61 acquired by camera module 15. Raw image 61 may exhibit lens distortion based on the lens 13 used by camera module 15 to acquire raw image 61. Like the example of FIG. 5, the type and amount of lens distortion may be specific to each lens 13 available for use with camera modules 15 of computing device 10. In addition, the type and amount of lens distortion may be specific to the optical zoom setting of the particular lens 13 used to capture raw image 61. Computing device 10 may include lens distortion data 60 that indicates the type and amount of lens distortion that will be present for one or more lenses and/or optical zoom settings of camera module 15.

ISP 23 includes image processing unit 50 and configuration with lens distortion correction unit 25. As described above in FIG. 1, image processing unit 50 of ISP 23 may perform any number of image processing techniques on raw image 61, including lens distortion correction, white balance adjustment, color correction, or other post-processing operations. In some examples, image processing unit 50 may access lens distortion data 60 to determine the amount and type of lens distortion present in raw image 61 in order to apply appropriate lens distortion correction techniques to raw image 61. In general, image processing unit 50 may perform lens distortion correction as a function of an inverse distortion grid, where the inverse distortion grid is an inverse of the lens distortion produced by camera module 15.

In accordance with the techniques of this disclosure, rather than determining configuration settings from raw image 61, which includes lens distortion, configuration with lens distortion correction unit 25 may correct for any lens distortion in raw image 61 as part of the configuration settings determination process. For example, configuration with lens distortion correction unit 25 may include configuration unit 56, which is configured to perform configuration stats processing in accordance with a distortion grid classification.

In some example configuration stats processing techniques, an image is divided into cells having a size of MxN, where M and N are a number of pixels. M and N may be different values (e.g., rectangular cells) or may be the same value (e.g., square cells). In some examples, ISP 23 may be configured to accumulate statistics (e.g., sums, averages, standard deviations, minimum, maximums, modes, etc.) for certain pixel data for one or more of the MxN cells. As described above, contrast or phase difference information may be analyzed for auto focus. Brightness information may be analyzed for auto exposure control. Gray tones and color values may be analyzed for auto white balance. Regardless of the data being analyzed, the configuration stats processing may be performed over every cell of an image, or for one or more specific ROIs of the image. As discussed above, if configuration stats processing is performed on an image having lens distortion, the accuracy of any determined configuration settings may be less than optimal. In particular, if configuration stats processing is performed on a specific ROI of an image having more distortion (e.g., in a Touch ROI example), the determined configuration settings may be inaccurate and/or not match user expectations.

Accordingly, in the example of FIG. 8, configuration unit 56 may use lens distortion data 60 to perform configuration stats processing on a distorted grid. Based on the type and amount of distortion present in raw image 61 (e.g., based on the lens and/or zoom settings used), configuration unit 56 may determine a distortion grid (e.g., from lens distortion data 60) that models the lens distortion in the image. Configuration unit 56 may first divide the raw image into MxN cells, and may then classify each of the pixels in the MxN cells into distorted grid cells based on lens distortion data 60.

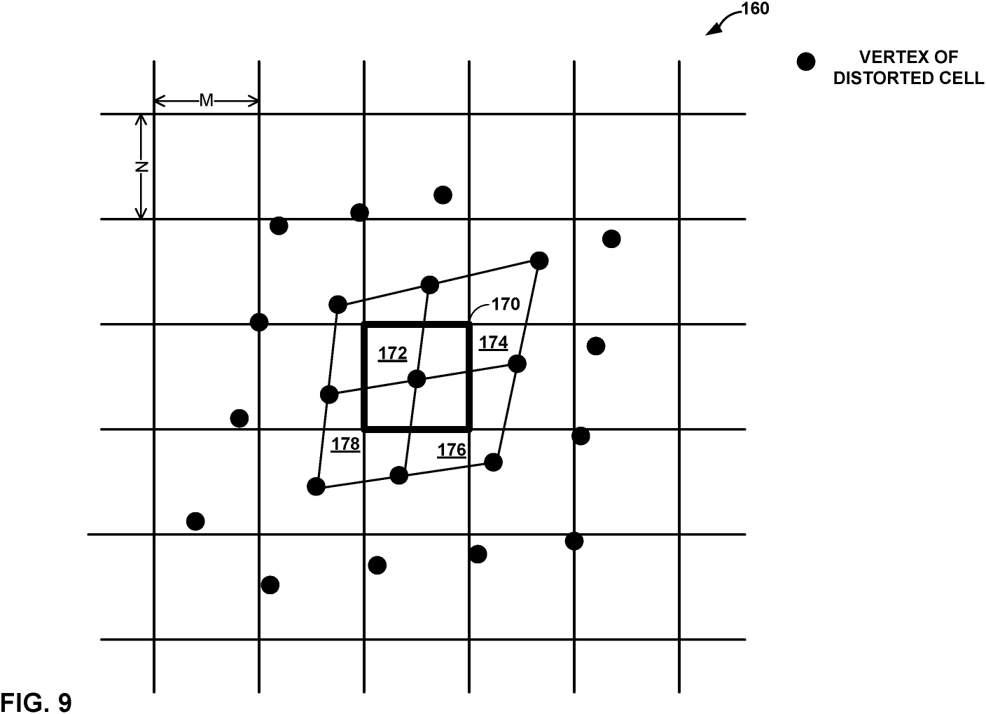

FIG. 9 is a conceptual diagram showing an example of a distorted grid used for configuration statistics processing in accordance with one example of the disclosure. FIG. 9 shows a region 160 of raw image 61. As can be seen in FIG. 9, region 160 is divided into a plurality of MxN cells, including cell 170. Overlaid on region 160 are vertices of a distorted grid from lens distortion data 60 (e.g., a portion of distorted grid 140 of FIG. 6). Configuration unit 56 may classify each pixel in cell 170 into a particular distorted grid cell. As shown in FIG. 9, the pixels of cell 170 may be classified into distorted grid cells 172, 174, 176, or 178. Once classified, configuration unit 56 may then perform statistics processing on the image data in the distorted grid cells and may determine configuration settings from that processing. Configuration unit 56 may use any of the techniques described above with reference to FIG. 1. Configuration unit 56 may send AF and AE settings to camera module 15. Camera module 15 may use the AF and AE settings to acquire subsequent images. Configuration unit 56 may also send AWB settings (e.g., an AWB gain) to image processing unit 50. Image processing unit 50 may use the AWB setting to apply an AWB gain to subsequently acquired images.

Accordingly, in one example of the disclosure, to determine the one or more configuration settings, ISP 23 divide raw image 61 having the lens distortion into cells, classify pixels in each of the cells into distortion grid cells based on the lens distortion, and perform statistics processing on the pixels in the distortion grid cells to determine the one or more configuration settings.

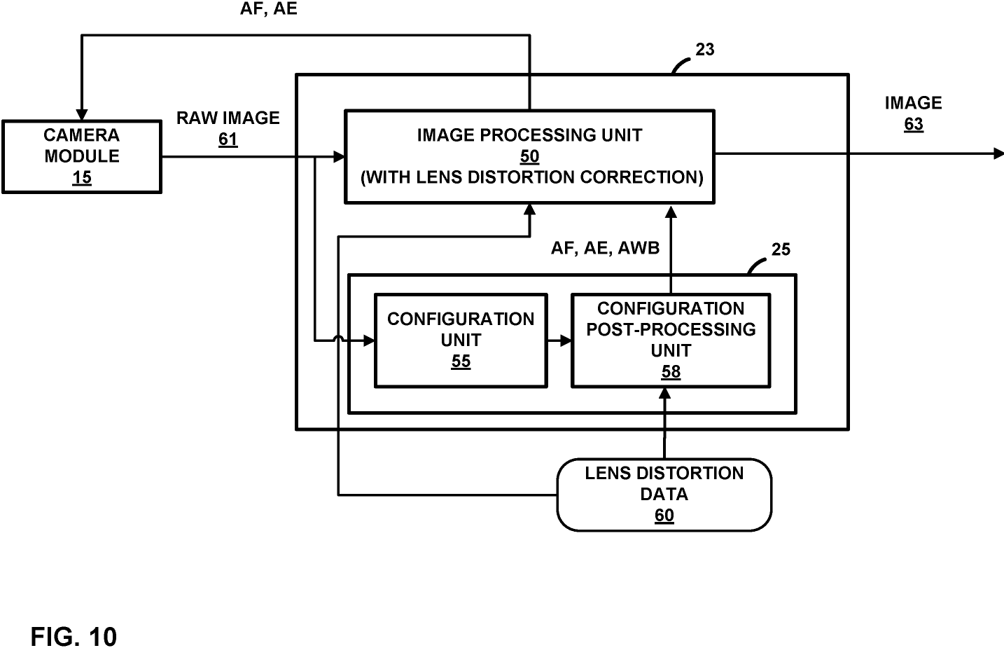

FIG. 10 is a block diagram showing another example of configuration statistics processing based on lens distortion in accordance with the techniques of the disclosure. In the example of FIG. 10, ISP 23 again receives a raw image 61 acquired by camera module 15. Raw image 61 may exhibit lens distortion based on the lens 13 used by camera module 15 to acquire raw image 61. Like the example of FIG. 5 and FIG. 8, the type and amount of lens distortion may be specific to each lens 13 available for use with camera modules 15 of computing device 10. In addition, the type and amount of lens distortion may be specific to the optical zoom setting of the particular lens 13 used to capture raw image 61. Computing device 10 may include lens distortion data 60 that indicates the type and amount of lens distortion that will be present for one or more lenses and/or optical zoom settings of camera module 15.

ISP 23 includes image processing unit 50 and configuration with lens distortion correction unit 25. As described above in FIG. 1, image processing unit 50 of ISP 23 may perform any number of image processing techniques on raw image 61, including lens distortion correction, white balance adjustment, color correction, or other post-processing operations. In some examples, image processing unit 50 may access lens distortion data 60 to determine the amount and type of lens distortion present in raw image 61 in order to apply appropriate lens distortion correction techniques to raw image 61. In general, image processing unit 50 may perform lens distortion correction as a function of an inverse distortion grid, where the inverse distortion grid is an inverse of the lens distortion produced by camera module 15.

In accordance with the techniques of this disclosure, rather than determining configuration settings from raw image 61, which includes lens distortion, configuration with lens distortion correction unit 25 may correct for any lens distortion in raw image 61 as part of the configuration settings determination process. For example, configuration with lens distortion correction unit 25 may include configuration unit 55 and configuration post-processing unit 58. Configuration post-processing unit 58 may be configured to adjust the configuration stats determined by configuration unit 55 based on lens distortion data 60.

Configuration unit 55 may be configured to determine initial configuration statistics values from raw image 61 having the lens distortion. For example, configuration unit 55 may divide raw image 61 into cells having a size of MxN, where M and N are a number of pixels. M and N may be different values (e.g., rectangular cells) or may be the same value (e.g., square cells). In some examples, configuration unit 55 may be configured to accumulate statistics (e.g., sums, averages, standard deviations, minimum, maximums, modes, etc.) for certain pixel data for one or more of the MxN cells. As described above, contrast or phase difference information may be analyzed for auto focus. Brightness information may be analyzed for auto exposure control. Gray tones and color values may be analyzed for auto white balance. Regardless of the data being analyzed, configuration unit 55 may be configured to accumulate configuration statistics over every cell of an image, or for one or more specific ROIs of the image. As discussed above, if configuration stats processing is performed on an image having lens distortion, the accuracy of any determined configuration settings may be less than optimal. In particular, if configuration stats processing is performed on a specific ROI of an image having more distortion (e.g., in a Touch ROI example), the determined configuration settings may be inaccurate and/or not match user expectations.

Accordingly, in the example of FIG. 10, configuration post-processing unit 58 may use lens distortion data 60 to perform a post-processing function to adjust the configuration statistics values produced by configuration unit 55. Configuration post-processing unit 58 may then determine configuration settings from the adjusted configuration statistics. In one example, configuration post-processing unit 58 may determine a lens distortion weight table based on the type and amount of distortion present in raw image 61. In one example, configuration post-processing unit 58 may determine weights for the lens distortion weight table based on an inverse distortion grid (e.g., inverse distortion grid 142 of FIG. 7 for barrel distortion) that could be used to perform lens distortion correction.

For example, for the initial statistics value in each cell of initial configuration statistics value produced by configuration unit 55, configuration post-processing unit 58 may multiply the corresponding weight from the lens distortion weight table to produce adjusted configuration statistics values. That is, the lens distortion weight table includes one value for each cell of statistics values produced by configuration stats process unit 35. That is configuration stats post [M][N] = configuration stats[M][N] * lensDistortionWeightTable[M][N], where configuration stats post are the configuration statistics values after applying the weights, configuration stats are the initial configuration statistics values, and lensDistortionWeightTable[M][N] are the weights for each MxN cell.

In some examples, the lens distortion weight table may be stored in lens distortion data 60. In other examples, configuration post-processing unit 58 may determine the lens distortion weight table. Each MxN cell (e.g., the rectangular cells the image is divided into) corresponds to a particular weight in the lens distortion weight table. Each MxN cell also corresponds to a particular distorted cell in an inverse distortion grid (e.g., inverse distortion grid 142 of FIG. 7 for barrel distortion). The area of each inverse distorted grid cell is the weight for that entry of the lens distortion weight table.

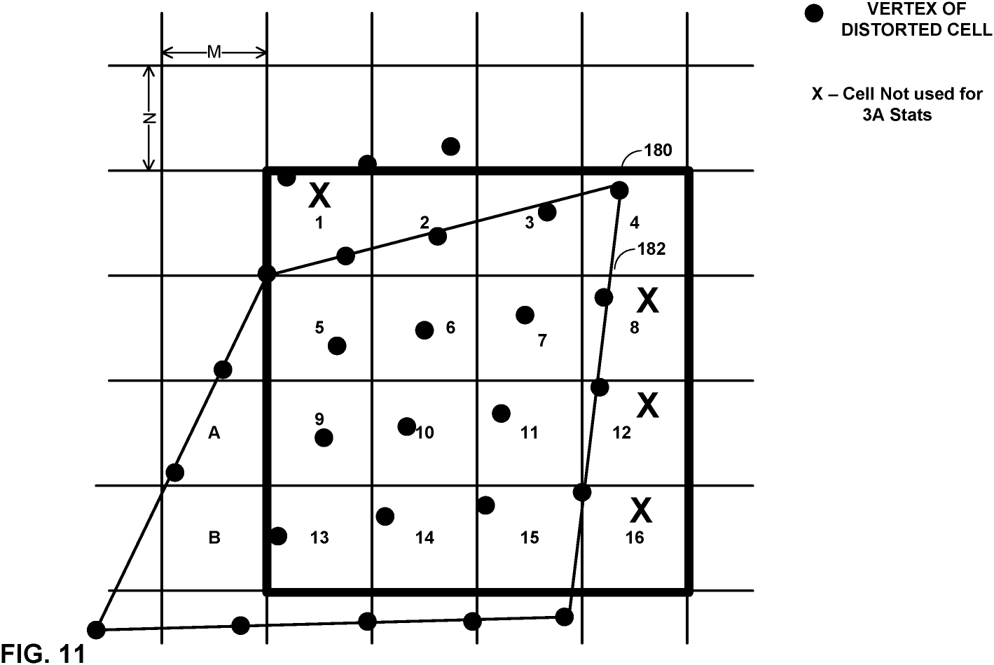

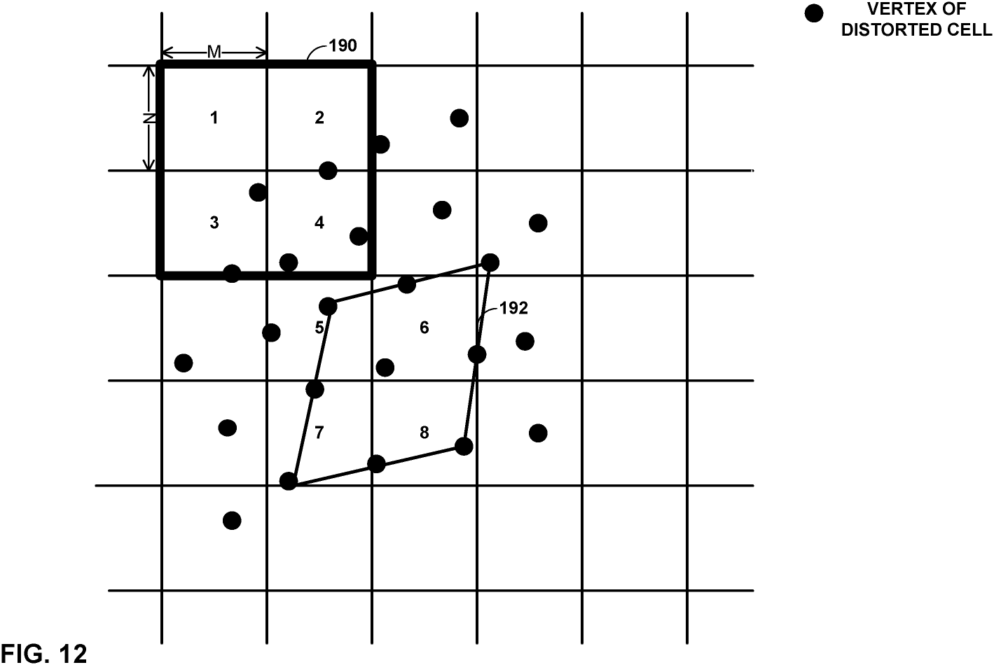

In other examples where configuration settings are to be determined for a particular ROI, configuration post-processing unit 58 may use a mapping function to determine which initial configuration statistics values to use when determining the configuration settings. FIGS. 11 and 12 are conceptual diagrams illustrating an example of ROI selection based on lens distortion. In FIG. 11, configuration stats are to be determined from ROI 180. For example, a user may have touched a portion of a preview display image to indicate ROI 180. However, since the user touched a preview image where lens distortion has been corrected, ROI 180 actually corresponds to distorted ROI 182 in raw image 61. Distorted ROI 182 is based on a distortion gird stored in lens distortion data 60.

FIG. 11 shows cells 1-16 in ROI 180. Configuration post-processing unit 58 may determine which cells of ROI 182 substantially overlap an MxN cell used by configuration unit 55. For example, configuration post-processing unit 58 may determine which of MxN cells 1-16 are within ROI 182 relative to some predetermined threshold. For example, some predetermined number of pixels of cell must be within a distorted grid cell for configuration post-processing unit 58 to use the corresponding initial configuration stats values when determining configuration settings.

In the example, of FIG. 11, cells 2-4, 5-7, 9-11, and 13-15 are substantially within ROI 182. However, cells 1, 8, 12, and 16 are not. As such, configuration post-processing unit 58 may only use statistics values from cells 2-4, 5-7, 9-11, and 13-15 to determine configuration settings. In addition, in some examples, configuration post-processing unit 58 may further use initial statistics values from cells outside of ROI 180. For example, in FIG. 11, configuration post-processing unit 58 may further use the statistics values from cells A and B. In the example of FIG. 12, configuration post-processing unit 58 may use the statistics values of cells 5-8 to determine configuration settings for a region of interest 190 that included initial statistics values from cells 1-4. This is because ROI 192 is the corresponding distorted ROI to ROI 190 that was indicated from an undistorted image.

Accordingly, in one example of the disclosure, to determine the one or more configuration settings, ISP 23 may determine initial configuration statistics values from the image having the lens distortion, and may adjust the initial configuration statistics values based on the lens distortion to determine adjusted configuration statistics values. ISP 23 may then determine the one or more configuration settings from the adjusted configuration statistics values. In one example, to adjust the initial configuration statistics values based on the lens distortion, ISP 23 is further configured to apply a weight table to the initial configuration statistics values, wherein the weight table is based on the lens distortion.

In other examples, ISP 23 may apply lens distortion correction to the image to form a corrected image, and cause the corrected image to be displayed. ISP 23 may further receive an input indicating ROI of the corrected image, and determine the one or more configuration settings from a corresponding ROI of the image based on the lens distortion. For example, ISP 23 may divide the image having the lens distortion into cells, determine, based on the lens distortion, one or more cells that correspond to the ROI of the corrected image, determine configuration statistics values from the determined one or more cells, and determine the one or more configuration settings from the determined configuration statistics.

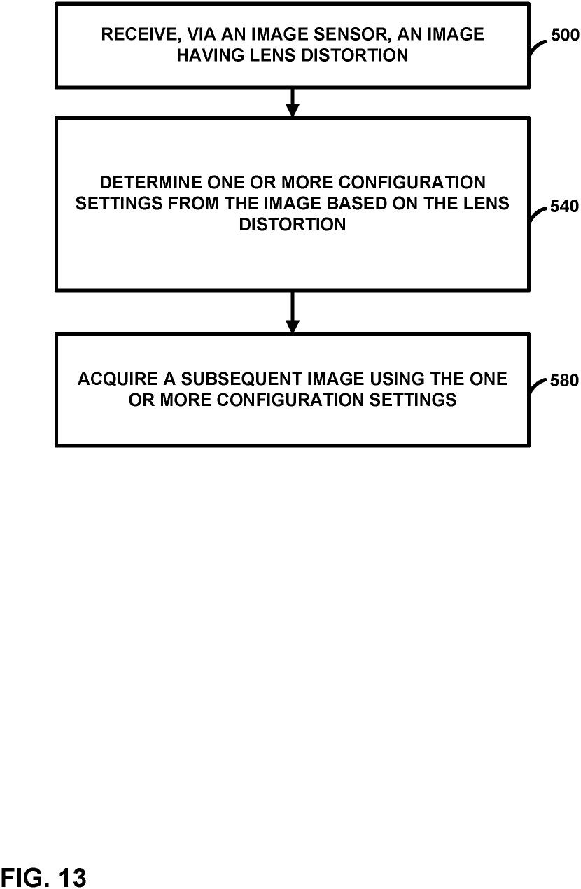

FIG. 13 is a flowchart illustrating an example method of the disclosure. The techniques of FIG. 13 may be performed by one or more structural components of computing device 10 of FIG. 1, including ISP 23 of camera processor(s) 14.

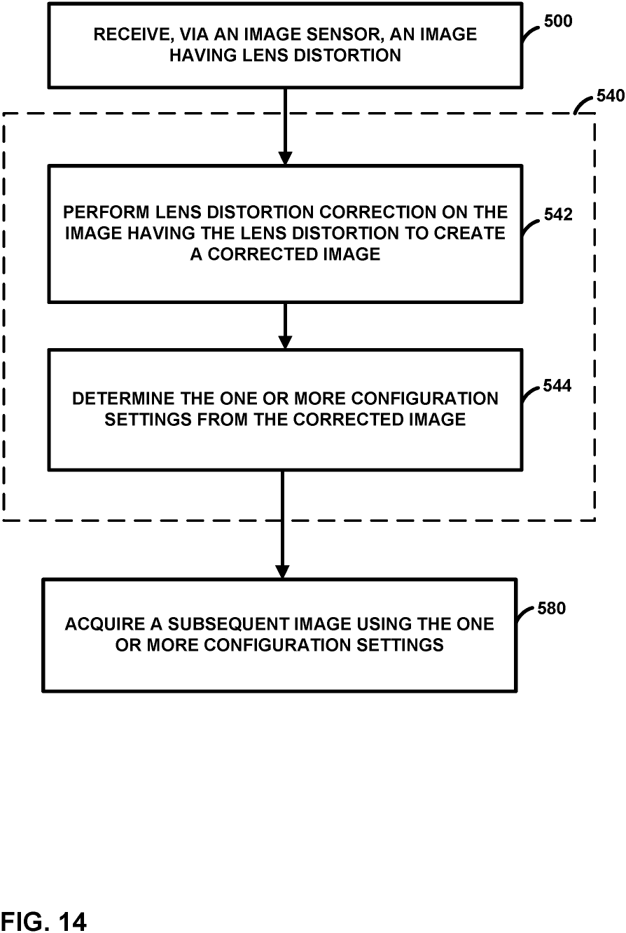

In one example of the disclosure, camera processor(s) 14 may be configured to receive, via an image sensor, an image having lens distortion (500). The amount of and type of lens distortion in the image may be dependent at least in part on the lens used with the image sensor. In some examples, camera processor(s) 14 may include lens distortion data (e.g., a lens distortion grid) for each of camera modules 15 of computing device 10. Camera processor(s) 14 may be configured to determine one or more configuration settings from the image based on the lens distortion, wherein the one or more configuration settings include an auto focus setting, an auto exposure control setting, or an auto white balance setting (540). FIGS. 14-16 describe different techniques for determining the configuration settings in more detail.

Camera processor(s) 14 may further be configured to acquire a subsequent image using the one or more configuration settings (580). For example, camera processor(s) may be configured to send a determined auto focus setting and/or an auto exposure control setting to camera module 15. Camera module 15 may then be configured to acquire a subsequent image using the determined auto focus setting and/or an auto exposure control setting. In other examples, camera processor(s) 14 may be configured to determine an auto white balance setting and then apply the auto white balance setting to images acquired from camera module 15, e.g., as a post-processing application applied by image processing unit 50.

In some examples, camera processor(s) 14 may be further configured to apply lens distortion correction to the image, substantially in parallel with determining the configuration statistics, to form a corrected image. Camera processor(s) 14 may be further configured to cause the corrected image to be displayed, e.g., as a preview image on display 28 of computing device 10 (see FIG. 1). In some examples, camera processor(s) 14 may be further configured to receive an input indicating a region-of-interest (ROI) of the corrected image, and determine the one or more configuration settings from a corresponding ROI of the image based on the lens distortion. In some examples, a user may indicate an ROI, e.g., including touching an area of an image being displayed. Camera processor(s) 14 may be further configured to determine configuration settings from image statistics in the corresponding ROI of the image based on the lens distortion.

FIG. 14 is a flowchart illustrating another example method of the disclosure. In the example, of FIG. 14, camera processor(s) 14 may be further configured to determine the one or more configuration settings (540), including performing lens distortion correction on the acquired image before performing configuration statistics processing. Like FIG. 13, camera processor(s) 14 may be configured to receive, via an image sensor of a camera module, an image having lens distortion (500). Camera processor(s) 14 may perform lens distortion correction on the image having the lens distortion to create a corrected image (542), and determine the one or more configuration settings from the corrected image (544). In one example, to perform lens distortion correction (542), camera processor(s) 14 may be further configured to determine a distortion grid related to the camera module, wherein the distortion grid defines the lens distortion produced by a lens of the camera module, determine an inverse grid related to the distortion grid, and perform lens distortion correction on the image as a function of the inverse grid.

Camera processor(s) 14 may further be configured to acquire a subsequent image using the one or more configuration settings (580). For example, camera processor(s) may be configured to send a determined auto focus setting and/or an auto exposure control setting to camera module 15. Camera module 15 may then be configured to acquire a subsequent image using the determined auto focus setting and/or an auto exposure control setting. In other examples, camera processor(s) 14 may be configured to determine an auto white balance setting and then apply the auto white balance setting to images acquired from camera module 15, e.g., as a post-processing application applied by image processing unit 50.

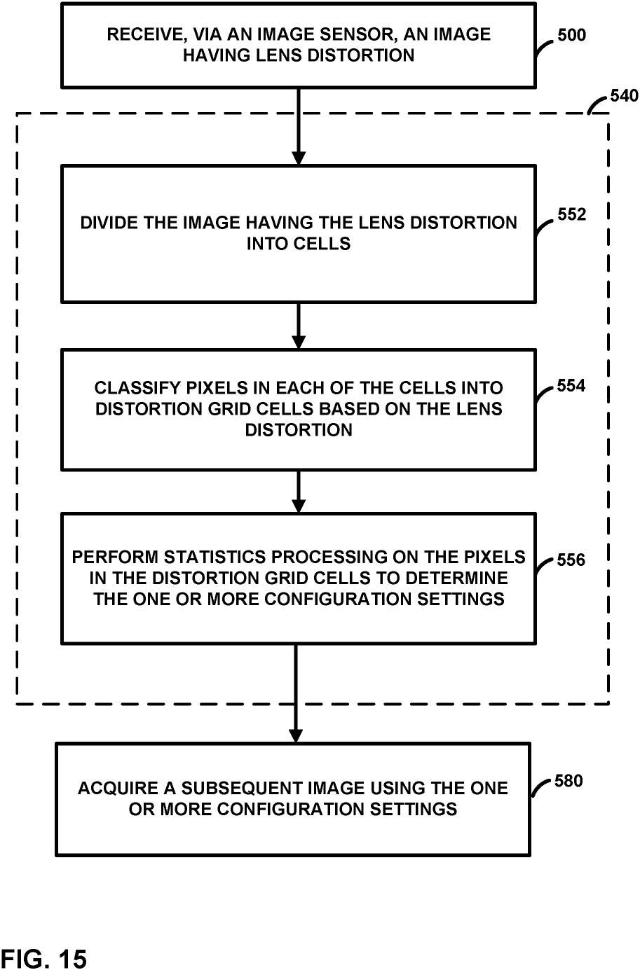

FIG. 15 is a flowchart illustrating another example method of the disclosure. In the example, of FIG. 15, camera processor(s) 14 may be further configured to determine the one or more configuration settings (540), including taking into account any lens distortion present in the acquired image during configuration statistics processing. Like FIG. 13, camera processor(s) 14 may be configured to receive, via an image sensor, an image having lens distortion (500). To determine the one or more configuration settings (540), camera processor(s) 14 may be further configured to divide the image having the lens distortion into cells (552), and classify pixels in each of the cells into distortion grid cells based on the lens distortion (554). Camera processor(s) 14 may then perform statistics processing on the pixels in the distortion grid cells to determine the one or more configuration settings (556).

Camera processor(s) 14 may further be configured to acquire a subsequent image using the one or more configuration settings (580). For example, camera processor(s) may be configured to send a determined auto focus setting and/or an auto exposure control setting to camera module 15. Camera module 15 may then be configured to acquire a subsequent image using the determined auto focus setting and/or an auto exposure control setting. In other examples, camera processor(s) 14 may be configured to determine an auto white balance setting and then apply the auto white balance setting to images acquired from camera module 15, e.g., as a post-processing application applied by image processing unit 50.

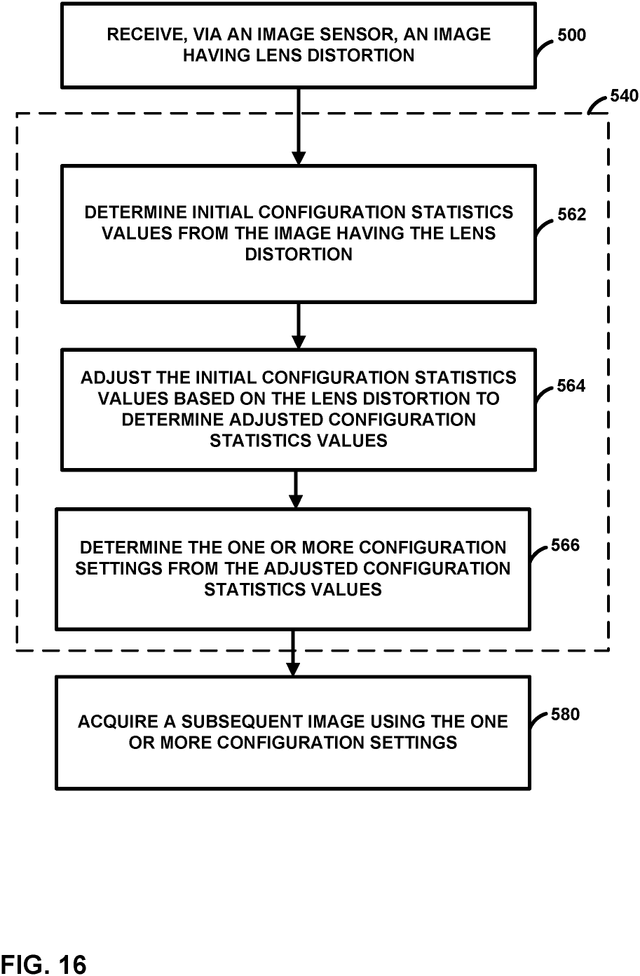

FIG. 16 is a flowchart illustrating another example method of the disclosure. In the example, of FIG. 16, camera processor(s) 14 may be further configured to determine the one or more configuration settings (540), including taking into account any lens distortion present in the acquired image. For example, camera processor(s) 14 may be configured to perform a post-processing operation after performing initial configuration statistics processing on the image having the lens distortion. Like FIG. 13, camera processor(s) 14 may be configured to receive, via an image sensor, an image having lens distortion (500). To determine the one or more configuration settings (540), camera processor(s) 14 may be further configured to determine initial configuration statistics values from the image having the lens distortion (562), and adjust the initial configuration statistics values based on the lens distortion to determine adjusted configuration statistics values (564). In one example, to adjust the initial configuration statistics values based on the lens distortion, camera processor(s) 14 may be configured to apply a weight table to the initial configuration statistics values, wherein the weight table is based on the lens distortion. Camera processor(s) 14 may then determine the one more configuration settings from the adjusted configuration statistics values (566).

Camera processor(s) 14 may further be configured to acquire a subsequent image using the one or more configuration settings (580). For example, camera processor(s) may be configured to send a determined auto focus setting and/or an auto exposure control setting to camera module 15. Camera module 15 may then be configured to acquire a subsequent image using the determined auto focus setting and/or an auto exposure control setting. In other examples, camera processor(s) 14 may be configured to determine an auto white balance setting and then apply the auto white balance setting to images acquired from camera module 15, e.g., as a post-processing application applied by image processing unit 50.

Additional illustrative examples of the disclosure are listed below.

Aspect 1 - An apparatus for camera processing, the apparatus comprising: means for receiving, via an image sensor, an image having lens distortion; means for determining one or more configuration settings from the image based on the lens distortion; and means for acquiring a subsequent image using the one or more configuration settings. In one example, the one or more configuration settings include an auto focus setting, an auto exposure control setting, or an auto white balance setting.

Aspect 2 - The apparatus of Aspect 1, wherein the means for determining the one or more configuration settings comprises: means for performing lens distortion correction on the image having the lens distortion to create a corrected image; and means for determining the one or more configuration settings from the corrected image.

Aspect 3 - The apparatus of Aspect 2, wherein the means for performing lens distortion correction comprises: means for determining a distortion grid related to a camera module including the image sensor, wherein the distortion grid defines the lens distortion produced by a lens of the camera module; means for determining an inverse grid related to the distortion grid; and means for performing lens distortion correction on the image as a function of the inverse grid.

Aspect 4 - The apparatus of Aspect 1, wherein the means for determining the one or more configuration settings comprises: means for dividing the image having the lens distortion into cells; means for classifying pixels in each of the cells into distortion grid cells based on the lens distortion; and means for performing statistics processing on the pixels in the distortion grid cells to determine the one or more configuration settings.

Aspect 5 - The apparatus of Aspect 1, wherein the means for determining the one or more configuration settings comprises: means for determining initial configuration statistics values from the image having the lens distortion; means for adjusting the initial configuration statistics values based on the lens distortion to determine adjusted configuration statistics values; and means for determining the one or more configuration settings from the adjusted configuration statistics values.

Aspect 6 - The apparatus of Aspect 5, wherein the means for adjusting the initial configuration statistics values based on the lens distortion comprises: means for applying a weight table to the initial configuration statistics values, wherein the weight table is based on the lens distortion.

Aspect 7 - The apparatus of Aspect 1, further comprising: means for applying lens distortion correction to the image to form a corrected image; and means for displaying the corrected image.

Aspect 8 - The apparatus of Aspect 7, further comprising: means for receiving an input of a region-of-interest (ROI) of the corrected image; and means for determining one or more configuration settings from a corresponding ROI of the image based on the lens distortion.

Aspect 9 - The apparatus of Aspect 8, wherein the means for determining the one or more configuration settings from a corresponding ROI of the image based on the lens distortion comprises: means for dividing the image having the lens distortion into cells; means for determining, based on the lens distortion, one or more cells that correspond to the ROI of the corrected image; means for determining configuration statistics values from the determined one or more cells; and means for determining the one or more configuration settings from the determined configuration statistics.

In one or more examples, the functions described may be implemented in hardware, software, firmware, or any combination thereof. If implemented in software, the functions may be stored on or transmitted over, as one or more instructions or code, a computer-readable medium and executed by a hardware-based processing unit. Computer-readable media may include computer-readable storage media, which corresponds to a tangible medium such as data storage media. In this manner, computer-readable media generally may correspond to tangible computer-readable storage media which is non-transitory. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, cache memory, or any other medium that can be used to store desired program code in the form of instructions or data structures and that can be accessed by a computer. It should be understood that computer-readable storage media and data storage media do not include carrier waves, signals, or other transient media, but are instead directed to non-transient, tangible storage media. Disk and disc, as used herein, includes compact disc (CD), laser disc, optical disc, digital versatile disc (DVD), floppy disk and Blu-ray disc, where discs usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units.

Various examples have been described. These and other examples are within the scope of the following claims.

What is claimed is:

1. An apparatus configured for camera processing, the apparatus comprising:
a memory configured to store one or more images; and
one or more processors in communication with the memory, the one or more processors configured to:
receive, via an image sensor, an image having lens distortion;
determine one or more configuration settings from the image based on the lens distortion; and
acquire a subsequent image using the one or more configuration settings.

2. The apparatus of claim 1, wherein the one or more configuration settings include an auto focus setting, an auto exposure control setting, or an auto white balance setting.

3. The apparatus of claim 1, wherein to determine the one or more configuration settings, the one or more processors are further configured to:
perform lens distortion correction on the image having the lens distortion to create a corrected image; and
determine the one or more configuration settings from the corrected image.

4. The apparatus of claim 3, wherein to perform lens distortion correction, the one or more processors are further configured to:
determine a distortion grid related to a camera module including the image sensor, wherein the distortion grid defines the lens distortion produced by a lens of the camera module;
determine an inverse grid related to the distortion grid; and
perform lens distortion correction on the image as a function of the inverse grid.

5. The apparatus of claim 1, wherein to determine the one or more configuration settings, the one or more processors are further configured to:
divide the image having the lens distortion into cells;
classify pixels in each of the cells into distortion grid cells based on the lens distortion; and
perform statistics processing on the pixels in the distortion grid cells to determine the one or more configuration settings.

6. The apparatus of claim 1, wherein to determine the one or more configuration settings, the one or more processors are further configured to:
determine initial configuration statistics values from the image having the lens distortion;
adjust the initial configuration statistics values based on the lens distortion to determine adjusted configuration statistics values; and
determine the one or more configuration settings from the adjusted configuration statistics values.

7. The apparatus of claim 6, wherein to adjust the initial configuration statistics values based on the lens distortion, the one or more processors are further configured to:
apply a weight table to the initial configuration statistics values, wherein the weight table is based on the lens distortion.

8. The apparatus of claim 1, wherein the one or more processors are further configured to:
apply lens distortion correction to the image to form a corrected image; and
cause the corrected image to be displayed.

9. The apparatus of claim 8, wherein the one or more processors are further configured to:
receive an input indicating a region-of-interest (ROI) of the corrected image; and
determine the one or more configuration settings from a corresponding ROI of the image based on the lens distortion.

10. The apparatus of claim 9, wherein the one or more processors are further configured to:
perform an ROI detection process on the corrected image; and
receive the input indicating the ROI of the corrected image based on the ROI detection process.

11. The apparatus of claim 10, wherein the ROI detection process is a face detection process.

12. The apparatus of claim 9, further comprising:
a camera module; and
a display configured to display the corrected image.

13. The apparatus of claim 12, wherein the one or more processors are further configured to:
receive the input of the ROI of the corrected image from a user.

14. The apparatus of claim 12, wherein the display comprises a touchscreen, and wherein the one or more processors are further configured to:
receive the input of the ROI of the corrected image from a user selection on the touchscreen.

15. A method of camera processing, the method comprising:
receiving, via an image sensor, an image having lens distortion;
determining one or more configuration settings from the image based on the lens distortion; and
acquiring a subsequent image using the one or more configuration settings.

16. The method of claim 15, wherein the one or more configuration settings include an auto focus setting, an auto exposure control setting, or an auto white balance setting.

17. The method of claim 15, wherein determining the one or more configuration settings comprises:
performing lens distortion correction on the image having the lens distortion to create a corrected image; and
determining the one or more configuration settings from the corrected image.

18. The method of claim 17, wherein performing lens distortion correction comprises:
determining a distortion grid related to a camera module including the image sensor, wherein the distortion grid defines the lens distortion produced by a lens of the camera module;
determining an inverse grid related to the distortion grid; and
performing lens distortion correction on the image as a function of the inverse grid.

19. The method of claim 15, wherein determining the one or more configuration settings comprises:
dividing the image having the lens distortion into cells;
classifying pixels in each of the cells into distortion grid cells based on the lens distortion; and
performing statistics processing on the pixels in the distortion grid cells to determine the one or more configuration settings.

20. The method of claim 15, wherein determining the one or more configuration settings comprises:
determining initial configuration statistics values from the image having the lens distortion;
adjusting the initial configuration statistics values based on the lens distortion to determine adjusted configuration statistics values; and
determining the one or more configuration settings from the adjusted configuration statistics values.

21. The method of claim 20, wherein adjusting the initial configuration statistics values based on the lens distortion comprises:
applying a weight table to the initial configuration statistics values, wherein the weight table is based on the lens distortion.

22. The method of claim 15, further comprising:
applying lens distortion correction to the image to form a corrected image; and
displaying the corrected image.

23. The method of claim 22, further comprising:
receiving an input indicating a region-of-interest (ROI) of the corrected image; and
determining one or more configuration settings from a corresponding ROI of the image based on the lens distortion.

24. The method of claim 23, further comprising:
performing an ROI detection process on the corrected image; and
receiving the input indicating the ROI of the corrected image based on the ROI detection process.

25. The method of claim 24, wherein the ROI detection process is a face detection process.

26. A non-transitory computer-readable storage medium storing instructions that, when executed, cause one or more processors of a device for camera processing to:
receive, via an image sensor, an image having lens distortion;
determine one or more configuration settings from the image based on the lens distortion; and
acquire a subsequent image using the one or more configuration settings.

27. The non-transitory computer-readable storage medium of claim 26, wherein the one or more configuration settings include an auto focus setting, an auto exposure control setting, or an auto white balance setting.

28. The non-transitory computer-readable storage medium of claim 26, wherein to determine the one or more configuration settings, the instructions further cause the one or more processors to:
perform lens distortion correction on the image having the lens distortion to create a corrected image; and
determine the one or more configuration settings from the corrected image.

29. The non-transitory computer-readable storage medium of claim 26, wherein to determine the one or more configuration settings, the instructions further cause the one or more processors to:
divide the image having the lens distortion into cells;
classify pixels in each of the cells into distortion grid cells based on the lens distortion; and
perform statistics processing on the pixels in the distortion grid cells to determine the one or more configuration settings.

30. The non-transitory computer-readable storage medium of claim 26, wherein to determine the one or more configuration settings, the instructions further cause the one or more processors to:
determine initial configuration statistics values from the image having the lens distortion;
adjust the initial configuration statistics values based on the lens distortion to determine adjusted configuration statistics values; and
determine the one or more configuration settings from the adjusted configuration statistics values.
